(19) United States
(12) Patent Application Publication
(10) Pub. No.: US 2002/0194759 A1
(43) Pub. Date: Dec. 26, 2002

(54) Cinema-like still pictures display for travelling spectators

(76) Inventors: Juan M. Badaracco, Buenos Aires (AR); Gustavo E. Estevez, Capital Federal (AR)

Correspondence Address: HEDMAN & COSTIGAN, P.C., 1185 Avenue of the Americas, New York, NY, 10036, US

(21) Appl. No.: 10/155,198

(22) Filed: May 24, 2002

Related U.S. Application Data
(63) Continuation-in-part of application No. 09/065,625, filed on Apr. 24, 1998, now abandoned.

(51) Int. Cl. G09F 19/14

(52) U.S. Cl. 40/453

(57) ABSTRACT

A static display system mounted to an underground tunnel wall exhibits movie style images to passing passengers. Trip means control lighting of each image as the passenger carriages pass by. Extended lighting circuit means control duration of the lighting of each image for optimum contrast and viewability from the passengers point of view. The images are displayed by film reel means attached to framework means having guides which simplify changing the reels. Each reel segment contains about five image frames.

### CROSS-REFERENCE TO RELATED APPLICATION

This is a continuation-in-part of my U.S. patent application Ser. No. 09/065,625 filed on Apr. 28, 1998.

### BACKGROUND OF THE INVENTION

The present invention relates to a static-film device which exhibits a moving image from fixed pictures to passengers on a moving train. In particular, this invention may be applied to exhibit advertising shorts to subway passengers.

There is an important period of time while the subway travels through a tunnel during which the passengers do not have much choice but to look at some poster in front of them, read a book or newspaper, dose or just gaze outside at the darkness of the tunnel. This tunnel darkness represents an idle waste of real-estate space and passenger minutes in terms of advertising potential, which repeats itself time and again between stations, until the passenger gets off.

It is sufficient to say that advert shorts on television, to name a widely used public viewing means, generally last about 10 or 20 seconds, while subway trains usually exceed this time interval in tunnels between leaving a station and arriving at the next stop. Hence there is an enormous advertising potential to be gained by filling this gap if a manner may be found to capture commuters' attention and convey them an advertising message.

The basic requirements of such a system are:

a—Adequate luminosity contrast between the image and the viewer. Either the tunnel should be naturally or made sufficiently dark or a system realized to enhance contrast.

b—The speed of the vehicle should be such that the images are projected at a rate of 24 frames/second, as dictated by long-standing cinema practice.

c—The size of the image should be in proportion to the size of the window for maximum view area.

d—The effective distance between the image frame and the train window should also be accounted for.

Technically, for a train or vehicle travelling at V=50 Km/h and a projection rate of T=24 frames/second, the width W of each frame should be:

W=V×T=50 Km/h×1/24 sec=58 centimeters.

For an advertisement short lasting e.g. 20 seconds, the number N of frames should be:

N=24 frames/sec×20 sec=480 frames.

Hence the total length L of the frame reel may be calculated as:

L=N×W=480 frames×0.58 meters=278 meters.

### SUMMARY OF THE PRIOR ART

Several attempts have been made to use subway tunnels for displaying advertising messages. European patent 393,243, Russian patent 2,010,349 and Japanese patent 3,175,487 suggest means for conveying independent images placed in a tunnel, however none disclose nor infer dynamically relating the display to instant passenger parameters such as position, speed or acceleration for providing a continuous-concept (i.e. cinema-like) display. Specifically, European patent 393,243 discloses spacing picture frames in boxes at a constant distance apart where the trains are presumed to be travelling at a constant speed, to be viewed by commuters through obscurating slits in the boxes.

A further approach, brought forward in U.S. Pat. No. 3,704,064 to Sollogoub et al, suggests a system preferably mounted in the portion where the train has uniform speed. When the system is passed by a train having some acceleration or deceleration, time-distortion becomes apparent to the passenger, causing a similar effect to a viewer of a conventional movie film should the projector slow down or speed up. Thus, Sollogoub fails to compensate for passenger change of speed in a system of equally spaced picture frames.

In short distances between stations, as is the general subway case, the train acceleration/deceleration distances and times are not negligible, for instance relative to the constant speed intermediate tunnel portion. Therefore, there is a substantial interest in providing a continuous cinema-like exhibition from the moment the train leaves the station and enters the tunnel, capturing the commuters attention from the start and before they routinely turn to some other distraction.

The prior art systems fail to achieve the quality of a cinema system becuase of the following technical factors:

a—If a train should happen to be slowed down by a railway signal in a tunnel, still images persist in the viewers eye for excessively long periods, making the image appear as a static succession of posters as opposed to a slow-motion film, which would be more desirable.

b—Each frame is successivly triggered once in the sequence resulting in flickering of the image at typical train speeds. It is impractical to reduce the size of the frames by half or to one third and maintain a proper viewable size without excessively extending the presentation.

c—Loss of perceived luminance becuase of a fixed lighting time which is kept short to avoid projecting an extended image such as having defects such as phantom images or shading at the edges

### BRIEF SUMMARY OF THE INVENTION

The present invention overcomes this waste through a series of fixed or static-film posters attached to the tunnels' walls which, coupled to the dynamics of the moving train, provide the passengers with moving images as in a film. Therefore, an object of the invention is to provide a substantially continuous reel of still picture frames giving the impression of a movie film short as perceived by moving paseengers.

Another object of the invention is to provide means sequentially illuminating the frames as the viewer(s) pass by at a relative speed, in particular for the practical case of passengers travelling in a train or vehicle.

A further object of the invention is to dimension the size and spacing of the frames for optimal cinema-like representation to the passengers relative to the distance from the train carriages and the size of the carriage windows.

Yet another object of the invention is to avoid or at least minimze interference as seen by different passengers between adjacent frames as they are sequentially lit.

Yet another object is to provide means to adapt the display to a variable range of train speeds, in particular when a train trudges slowly along a tunnel under railway signal restraints, causing excessive picture persistence in the eye.

Yet another object is to provide suitable illumination energy and duration for maximum luminance and minimum flickering or phantom image (persistence) defects).

Yet a further object is to provide movie film system for installation in a subway train tunnel which is relatively easy to maintain and upkeep, in particular enabling a particular film short to be replaced in a short time, such as in the few hours during which train service stops for the night.

Yet a further object is to provide means for mounting a movie film system to a subway train tunnel wall at a constant level relative to the railway tracks throughout the length of the tunnel.

Yet a further object is a movie film system installed in a subway train tunnel such that it is immune to environmental hazards such as water leaks through the wall and vibrations caused by the trains.

These and other objects and advantages are achieved by placing a series of pictures one alongside the other parallel to the travel direction of the train. Each poster exhibits a static image but with the aid of the poster next to it, the movie effect is obtained. To fix the poster image on the passenger's retina, the posters are lit during a short interval of time, determined by the speed of visual retention. Means are provided for mainting this time-interval each lamp is lit and providing dark intermediate intervals before each lamp is relit.

In a preferred embodiment, the energy for lighting the lamps is derived from capacitor charges which are replenished prior to each further map lighting event. Means are also preferably provided for enhancing darkness when the lamps are not lit.

### TERMINOLOGY

As used herein, “continuous” as referred to the film reel or image sequence means that adjacent frames are practically side by side or hardly separated, such that at all times inside the display portion of the tunnel there is usually one frame viewable to the passenger. In other words, the term “continuous” should be construed as synonimous to “uninterrupted” rather than “endless”.

As used herein, “poster” refers to the physical sheet of paper or the like having a “picture” on its forward facing surface. The pictures are sequenced in time such that the posters represent the frames of a film reel or the like; therefore adjacent pictures are generally similar but offset in time one frame. “Image” relates to the “picture” as perceived by the passengers.

As used herein, “flickering” is a cinema defect related to the perception of dark shadows between the frames such as when a film is projected at too slow a speed; whereas “phantom image” is another cinema defect related to the overlapping of sequential images or the movement of a same image frame in the eye of the spectator, resulting from the persistence of an image in the eye retinae. In the context of the present invention, “flickering” could result from the time-interval the image is lit being to short or the time befroe the next image is lit being too long and “phantom images” could result from the time-interval the image is lit being to long.

### BRIEF DESCRIPTION OF THE DRAWINGS

FIG. 1 is a perspective view of an underground tunnel wherein the static-film system of the invention is installed.

FIG. 2 is an elevational view of the system installed in the tunnel of FIG. 1, illustrating the spatial and dimensional interrelation between the pictures.

FIG. 3 is a block diagram of the system of the invention according to a preferred embodiment.

FIG. 4 is a schematic of the power supply for the system of FIG. 3.

FIG. 5 is a block diagram of an optical trip sensor for the system of FIG. 3.

FIG. 6 is a schematic of the optical trip sensor of FIG. 5.

FIG. 7 is a block diagram of a frame lighting circuit.

FIG. 8 is a schematic of the frame lighting circuit of FIG. 7.

FIG. 9 is a schematic of a lighting extension circuit for the system of FIG. 7.

FIG. 10 is a time-chart illustrating operation of the system.

FIG. 11 shows oscilloscope traces of voltage and current drawn by lamp loads.

FIG. 12 is an exploded perspective view showing a frame mount for optimizing luminance contrast.

### DETAILED DESCRIPTION OF A PREFERED EMBODIMENT

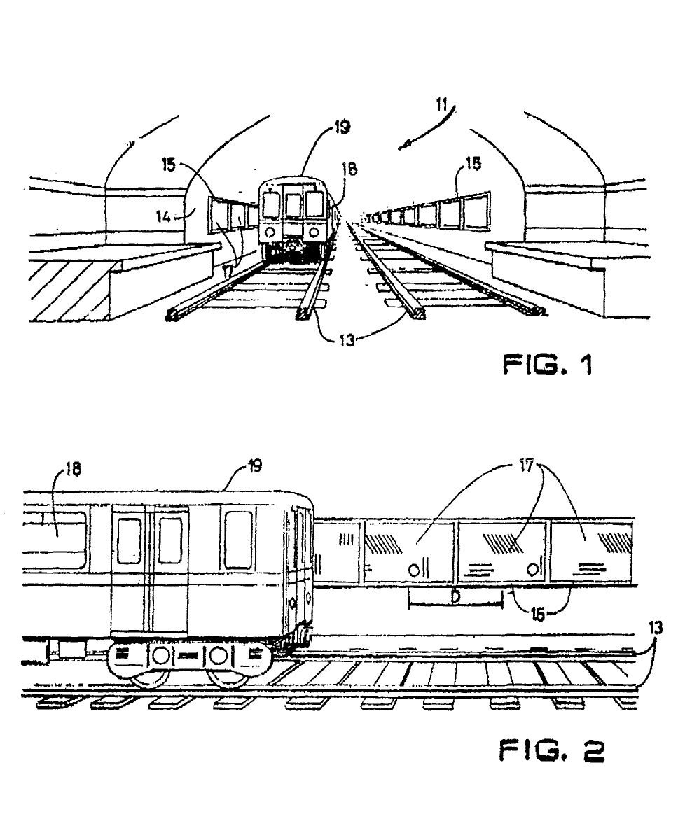

Referring to FIGS. 1 and 2, a subway tunnel 11 is shown with its pair of underground railway tracks 13 and side walls 14. A reel of static picture frames 15 is affixed extending horizontally at the same height as the windows 18 of the train 19 travelling on the tracks 13. Each frame 15 displays a still picture 17 which forms part of a dynamic sequence.

As has been known and used by the cinema industry for ages, the human eye assimilates visual stimuli at a constant rate not greater than 1/12 of a second. This, therefore, is the maximum allowable interval between passing from one picture 15 to the next. In this embodiment, the time-instant represented by the image 17 in each poster 15 is offset T=1/24 seconds from the previous one, in the traveling direction of the train 19. Furthermore, the longitudinal interval or distance D from centre to centre between adjacent posters 15 is equal to the distance covered by the train 19 in an equivalent time interval.

If the train 19 is considered to travel at a predetermined nominal constant speed of 50 Km/h, the posters 15 would be distributed along the tunnel 11 at D intervals of:

D=V×T=50 Km/hr×1/24 sec=58 centimeters≈0.6 meters.

This interval D of approximately 0.6 meters accounts for both the width of the picture 17 and a blank space in between posters 15.

Of course, the intervals from one poster 15 to another can be submultiples of the maximum D interval calculated above, in case images of smaller dimensions are required, so that the full image is visible and takes up the passengers' line of sight inside the train 19. A decisive parameter to determine the size of the images is the distance between the tracks 13 and the wall 14.

The poster frames 17 may comprise a 35 mm film, leaving a proportional space to the one that exists between the picture frames. The height H of the posters is determined from the desired aspect ratio of the picture frame 15.

The reel of posters 15 extends lengthwise along the wall 14 according to the duration of the static-film presentation, spanning the maximum stretch available inside the tunnel where the train travels at a constant speed. Even though sections close to stations where the train accelerates or brakes can be included, this requires looking for the right image according to the time that has passed since the beginning of the short, in a uniformly accelerated movement, or changing the amount of frames per second, recalling that the eye accepts up to 12 frames per second. As to the sequence timing of the pictures 17, the assumption is made that all trains generally move in a like manner, i.e acceleration/braking rates and places are standard for a particular line or stretch and that all underground trains will run at the same speed V, e.g. 50 km/hour in the constant-speed section in the middle of the tunnel.

In the present case, the images 17 refer to an advertising short having a duration At (advertising time) of 30 seconds, the posters 15 covering a stretch Al (advertising length) inside the tunnel 11.

Now, adding to the this movement the acceleration and deceleration time A, considering that A is continuous and approximately 0.85 meters per second squared, and knowing that the maximum speed V is 50 Km per hour and the stretches Lp′ in A.

Tp′=(V/A−V′/A)×2

The minimum V′ to display images is V/2=25 km/hour, enabling the times Tp′ to be determined:

Tp′=(13.89 m/sec/0.85 m/sec²−6.94 m/sec/0.85 m/sec²)×2=16.4 sec.

Lp′=1(/2×V/A)−(½×V′/A)×2.

Lp′=(0.5×13.9 m/sec/0.85 m/sec²)−(0.5×6.9 m/sec/0.85 m/sec²)×2≈170 meters.

That is to say, the intermediate length Lp′ of the short between the acceleration and deceleration periods will be of approximately 170 meters and the duration of 16.4 seconds. Consequently, if the duration of the short is 30 seconds, the time T″ that must be covered at a constant speed will be that of the total duration of the short minus the time T″, such that the distance Lp″ will be:

T″=30 sec−16.4 sec=13.6 sec

Lp″=V×T″

Lp″=13.9 m/sec×13.6 sec=190 meters

In other words, to set up an advertising short of 30 seconds duration, a reel of approximately 360 meters is installed on the wall 14, consisting of about 720 posters 15.

On the other hand, to fix the image on the passengers' retinae as the train 19 goes through the tunnel 11, it is necessary that each picture 17 remain lighted only a fraction of the time interval T that the train 19 passes in front of the poster 15. This can be achieved by providing the posters 15 with a quick lighting mechanism; for example T-period-switched laser lamps 18. Preferably, the brief lighting period is set by a timer controlled by a device which detects the passage of the train 19, in order to synchronize the turning-on of each poster 15 as the train 19 passes in front of each picture 17.

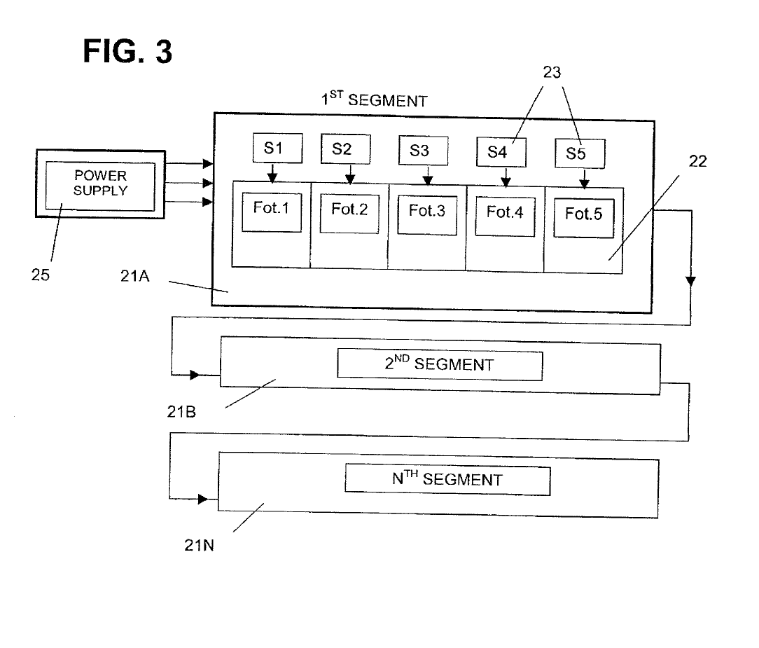

Each frame 15 is approximately 0.6 meters by 0.6 meters and four xenon lamps 18 are used for each, evenly distributed behind the picture images 17. FIG. 3 is a block diagram of the system including a plurality of circuit modules 21A, 21B . . . 21N, each holding five lighting circuits 22 for respective successive picture frames 15. Each lighting circuit is controlled by a trip sensor 23.

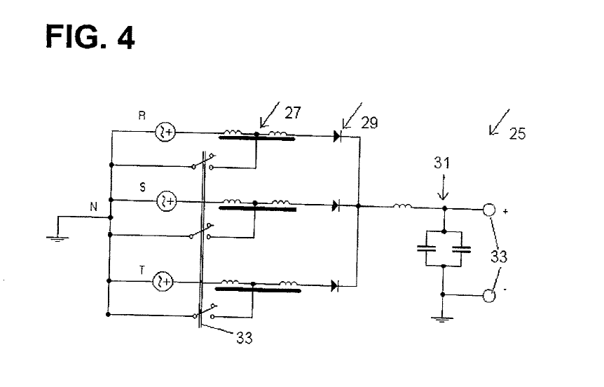

A power supply 25 runs the length of the tunnel to power each picture board. FIG. 4 illustrates a preferred power supply 25 for deriving a 340 volt DC outlet and a 220 V AC outlet from a three-phase 3×380 VAC line. The power supply 25 includes a typical three-phase transformer 27, rectifier diodes 29 and a ripple-arrester circuit 31 for providing 340 VDC at the outlet 33. The 220 VAC outlet may be derived from one or more shunt points intermediate the secondary transformer coils and the respective diode 29.

A three-phase switch or contactor 35 enables the autotransformer intermediate points to be disconnected from neutral to reduce starting current.

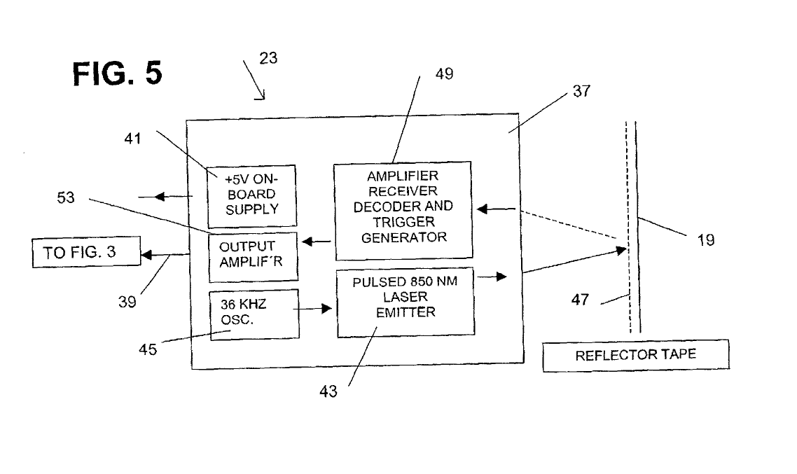

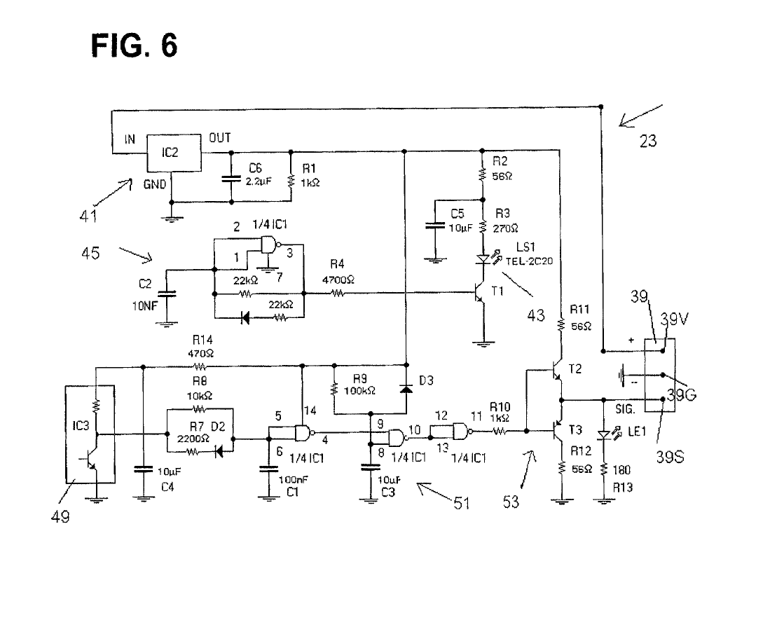

FIG. 5 ilustrates one of the optical sensor devices 23. Optical sensing is preferred to magnetic since it is more immune to electromagnetic noise in the tunnel caused by the train high-voltage drive installation and fluorescent illumination, for instance. The circuit illustrated in FIG. 6 according to a preferred embodiment implementing the block diagram of FIG. 5 is preferably mounted on a common printed circuit board 37. The sensor device 23 is connected to the lighting device via a three-terminal plug 39. A first terminal 39V inputs high voltage for an on-board voltage regulator supply 41 for providing 5V bias current to the electronic components. A second terminal 39G is ground and the third terminal 39S is the sensor output to the respective lighting circuit 22.

In order to avoid use of concentrator lenses and mirrors, it is preferable to use an 850-nm infrared laser emitter 43 driven by a 36 kHz oscillator 45 having a 50% duty cycle. The emitter 43 has a 4° aperture so as to provide, at a distance of 0.6 meters, an incident light spot having a maximum diameter of 2 cm. This arrangement provides high precision in positioning the light-up instant of the picture.

The train carriages 19 have reflective sides 47 so as deflect the incident light backwards so as to impinge on a phototransistor receiver 49. The receiver 49 amplifies and decodes the incident light and generates a trip signal for triggering the lighting device 22. The receiver 49 is operated at reduced sensitivity to obtain a high signal-to-noise ratio. The receiver 49 is provided with a light filter to supress emission bands generated by the xenon lamp 18 used for lighting the displays 15 in view of the wavelength overlap between the optical sensor emitter means 43 and the picture light 18.

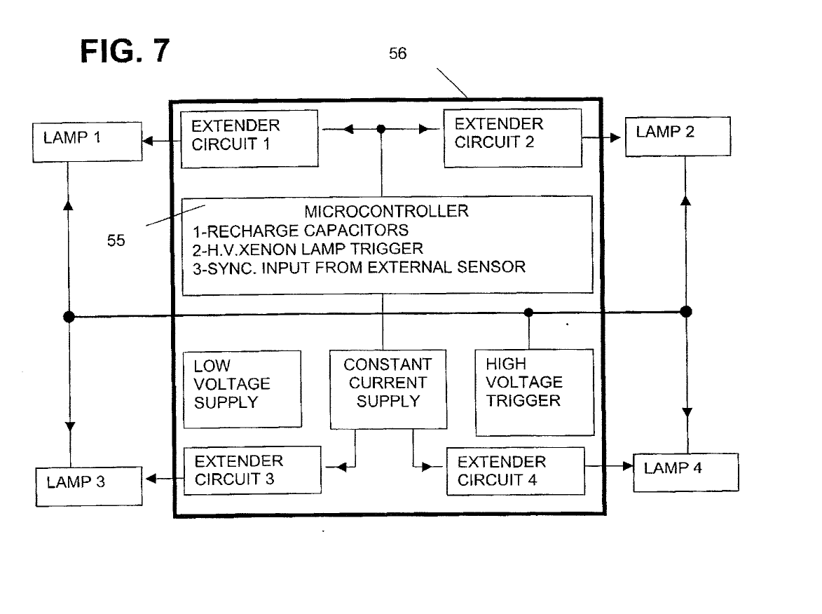

The receiver 49 has an output connected to a one-shot mono-stable device 51 to filter out false triggers due to electrical noise and spurious light reflections. The output from the one-shot device is passed through a Darlington amplifier stage 53 for producing a power signal at terminal 39S for a microcontroller stage 55 in the lighting device 22 of FIG. 7.

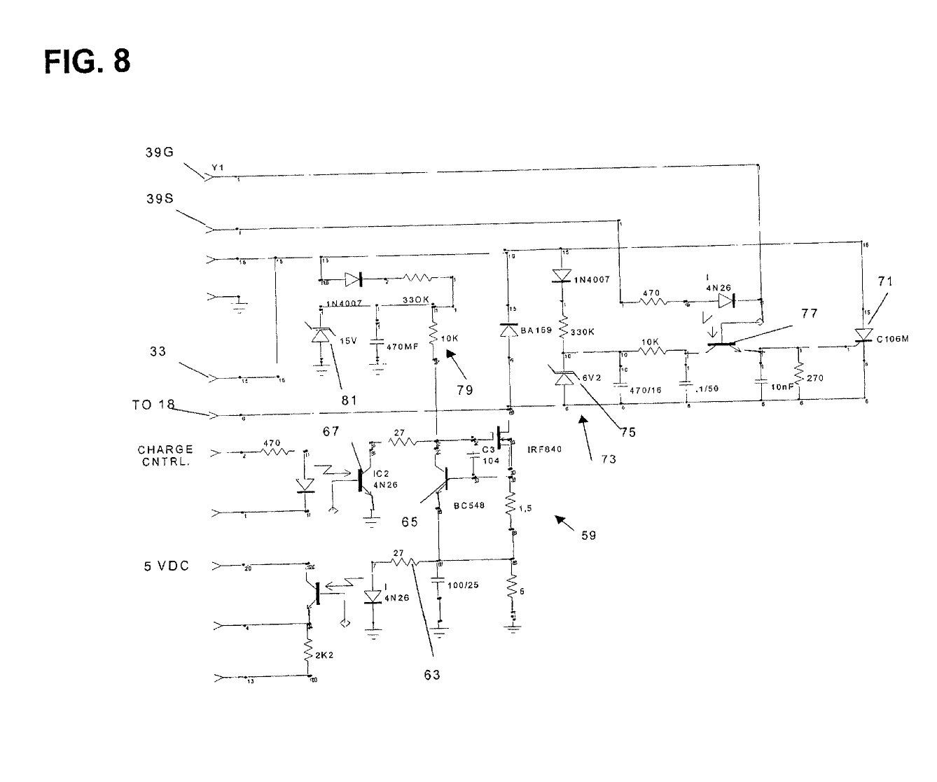

The block diagram of FIG. 7 actually corresponds to a lighting circuit board 56 which is physically located centrally behind the image frame 15, such that its four lamps 18 are approximately behind the middle of four quadrants in which the picture 17 may be geometrically partitioned. The microcontroller 55 is powered by twin 5V and 12V output supplies 57 and controls a 0.6-Amp current source 59. FIG. 8 is a schematic of a circuit board of the lighting device 22 illustrating, inter alia, the current source 59 in more detail. The current source 59 is built around an IRF840 mosfet transistor 61. The 0.6-Amp constant current is set by a 27 Ω resistor 63 connected to a BC548 transistor 65. The current source 59 is switched on and off by a signal outputted by the offboard microcontroller 55 through a 4N26 opto-coupler 67.

Since eye sensitivity is not lineal, i.e. light perception is an exponential magnification of light stimulation, the time-interval the lamps 18 are on, that is the time the stimulation dwells on the eye and persists in the retina, was found to be an important factor. Increased perception with less energy may be achieved by extending the light flash on the order of about 1 millisecond. Increased lighting time also reduces flickering and dark spots in the image.

Preferably, the lght flash interval should be between 500 and 1,500 microseconds. Shorter times increase flickering of the image and longer times increase image persistence on the retina causing phantom images to be perceived by the viewer.

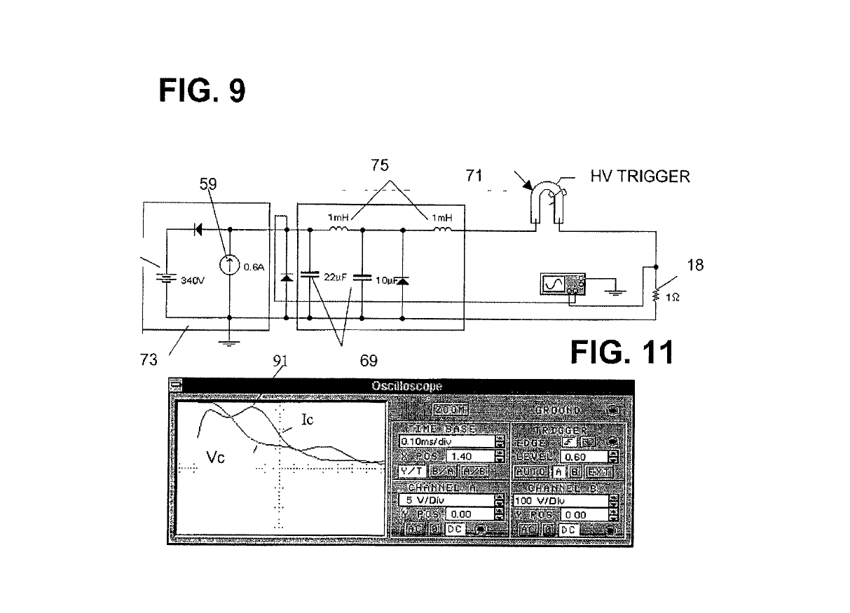

FIG. 9 is a schematic of the lighting circuit 22. An LC circuit 67 includes a capacitor bank 69 which is periodically recharged by the current source 59, under control of the microcontroller 55. Equivalent voltage source 68 symbolizes the afore-explained micro-controlled supply for the current source 59

The lighting circuit 22 uses CM106M thyristors (or SCRS) 71 located on circuit board 72 illustrated in FIG. 8 for gating current from the offboard capacitor bank 69 to the xenon light bulbs 18. The capacitor bank 69, comprising a 22 μF capacitor and a 10 μF capacitor in parallel illustrated in FIG. 9, provides the right amount of energy for the xenon lamps 18, when gated by a thyristor switch 71. The intensity and duration of the light flash is controlled by two 0.7 mH inductive components 75 illustrated in FIG. 9. Thus, a fixed amount of electrical energy resulting in short, predetermined lighting time-interval bursts through each thyristor 71 to its corresponding light load 18 each time it is gated.

Proper operation is achieved using coils made from copper wire 0.8 mm in diameter, contributing a resistance of 0.75 Ω each. Either electrolytic or polypropelene (better operation but bolkier and dearer) capacitors 69 dimensioned for 350 VAC may be used. The 22 μF-capacitor has a 3.9 Ω serial resistance and the 10 μF-capacitor a serial resistance of 13.2 Ω.

A power supply 73 includes a zener diode 75 for providing a 6.2 volt output to the thyristor gate through a transistor 77, such as a 4N26 opto-coupler transistor integrated circuit, opto-controlled by the sensor signal provided through terminal 39S. Another power supply 79 has a 15V output regulated by zener diode 81 for biasing the current source 59 recharging the capacitor bank 69. Both power supplies 73 and 79 are derived from the 300 VDC output terminal 33.

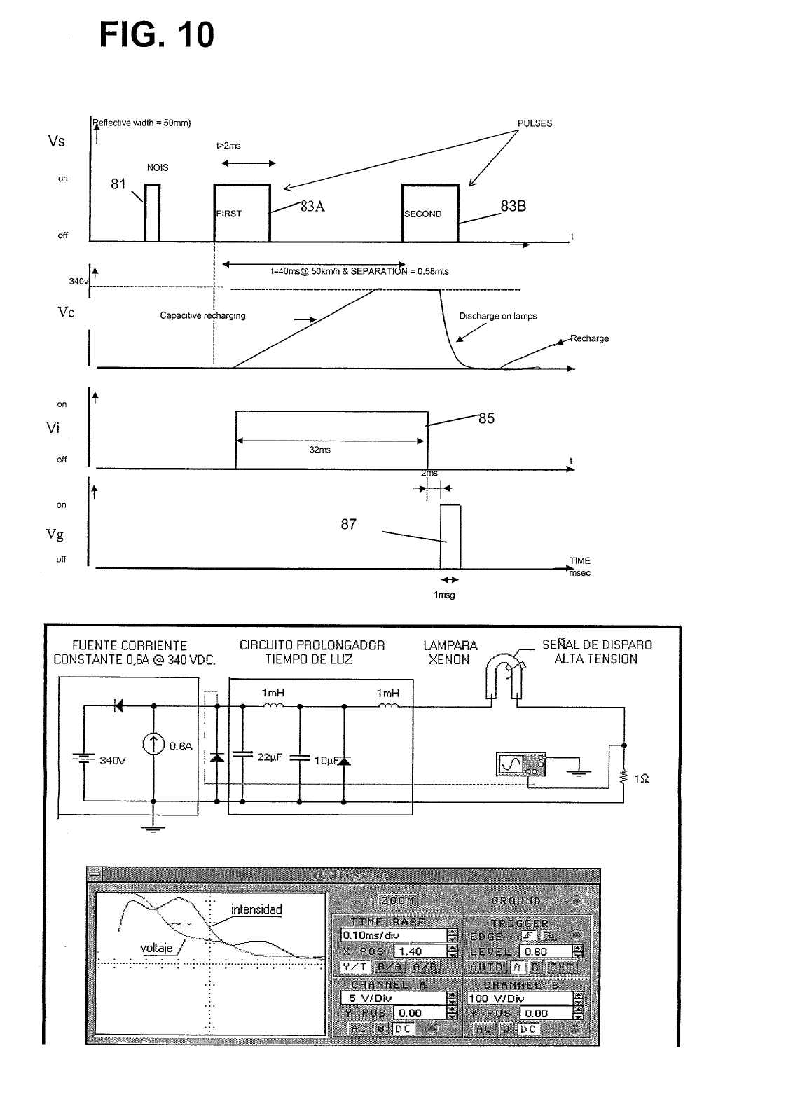

Operation is summarized by the graphs in FIG. 10. V_{S} is a binary signal transmitted from the sensor circuit 23 to a control input of the microcontroller 55. One of the microcontroller functions is to validate signals and reject spurious signals, by checking that a reflection pulse be at least 20 cycles (2 milliseconds) long. Pulse 81 is an example of a short spurious reflection which is rejected. When a trains goes by the sensor 49, a series of pulses 83A, 83B . . . are generated on line 39S. The microcontroller 55 takes the first validated pulse 83A and initiates the current source 59 to begin charging the capacitor bank 59. Graph V_{I} shows the control pulse signal 85 outputted from the microcontroller 55 and graph V_{C} the constant 0.6-A current charging of the capacitor bank 69. Capacitor charging continues for 32 milliseconds while the V_{I} signal is true.

Once sufficient time has elapsed for the current source 59 to fully charge the capacitors 69, the microcontroller turns the source control signal off, waits for 2 milliseconds for the current to die down and thereafter issues a 1 millisecond pulse 87 for trigering the thyristors 71, as illustrated in graph V_{G}. Each thyristor 71 responds by dumping the capacitor charge on the lamp load 18, as illustrated by the exponentially decaying curve 89 of graph V_{C}.

However, current across the load 18 does not decay as quickly as the voltage since the 22 μF capacitor 69A serves as an auxiliary source for recharging the 10 μF capacitor 69B as the latter is depleted by the lamp load, thereby extending the initial high power output gated through the thyristors 71. FIG. 11 is an oscilloscope graph of voltage V_{C} and current intensity I_{C} versus time. The effect of capacitor 69A recharging capacitor 69B during the lighting cycle is shown by the initial twin-peak or approximately table-mountain shape 91 of the current curve I_{C}.

Further LC cells may be added to the light extension circuit 67 if it is desired to extend the table-mountain top shape of the I_{C} current function. However, the time the lamp is kept lit should not exceed about 1 millisecond, otherwise flickering shadows or phanom images become perceivable around the edges of the image 17, as explained hereinabove.

The microcontroller 55 is programmed to monitor that the right events take place and avoid mislighting of the frames 15. It controls the rate of charge of the capacitor cell 69, that the lamps 18 flash and go out properly before initiating a next cycle. The microcontroller 55 also analyses the signal V_{S} generated by the light sensor device 23 for validation thereof as explained hereinbefore.

The microcontroller 55 also monitors the train speed and checks should it stop in front of a picture 15 (such as because of a red railway signal) or is otherwise moving too slow in which cases triggering of the flashes es disabled until a threshhold speed is attained.

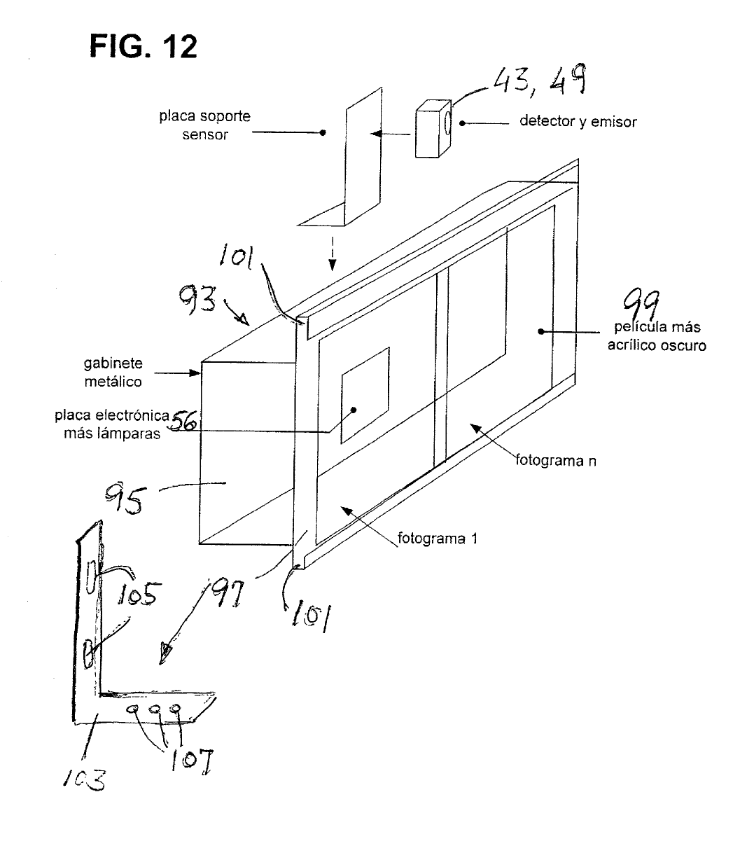

Another important feature of the system of the invention is the mounting of the frames to the tunnel walls using the mount of FIG. 12 so as to enhance contrast and project an optimum cinema-like movie image. The framework 93 comprises a metallic, box-shaped back panel 95 and a front panel 97 with translucid windows 99 facing towards the railway track 13. Each framework 93 prefeably comprises five back-panels 95. The top and bottom edges of the front panel 97 are provided with guides 101 for sliding a reel of pictures 17 in such that each frame 15 is positioned in front of a window 99. The box 95 houses the lighting circuit board 56 in the middle and slightly behind each window 99 such that four lamps 18 (FIG. 7) thereof are evenly distributed behind the surface of each window 99.

Distinctive features of the invention, such as the guides 101 and the use of reels for sliding in five picture frames at a time enable the advert running the whole length of the tunnel to be changed in just a few hours, which may be done while service has stopped for the night, such that the passengers may view an entirely new display from one day to the other. For instance, adverts may be changed every two months with five workers working about three hours. Other maintenance is not foreseen for the first five years of operation.

Each back-panel 95 is about 2.9 meters wide, 0.6 meters high and 18 centimeters deep, typically weighing about 30 kilogrammes with all its contents. Three L-shaped brackets 103 are used for mounting each back-panel 95 to the tunnel wall. The back-panels 95 are overdimensioned to support about 140 kilogrammes to resist the added weight of maintenance personnel or anyone else happening to step onto a box 93.

The brackets 103 are made of iron coated with zinc or cadmiun and mounted to the tunnel wall by means of suitable securement means passed through a couple of oblong holes 105 in the vertical arm of the bracket 103. The horizontal arm of the bracket 103 has one or more round holes 107 for inserting a bolt depending downwards from back-panel 95. The round holes 107 are placed at a set distance from the bracket angle in order to separate the back-panel 95 from the tunnel wall, say about 2 centimeters, so that moisture and water filtering through the tunnel wall runs down the wall without wetting the framework 93. Butterfly nuts may be used to secure the bolts although the weight of the framework 93 should keep the bolts in place in the holes 107.

The oblong holes 105 enable adjustment of the height of the framework 93 once all the boxes 95 have been mounted to the wall to make sure that all the picture frames are at the same level. This is important for optimal viewal on the part of the passengers. The correct position relative to the train is preferably adjusted using a Teodolite laser coupled to a personal computer.

The power supply 25 includes cables interconnecting adjacent panels 95 using AMP-type connectors. Apart from providing an easy way of powering the whole system down the length of the tunnel, safety for workers may be enhanced in the event a panel 95 needs to be disassembled for repair. All the worker has to do is to disconnect the two AMP connectors on either side of the panel to be certain that the panel is not powered.

The sensor array 43, 49 may be set up on the box 95, either on top or underneath each picture frame 15, according to the height of the reflector tape 47 on the side of the train 19.

The inwardly facing surface, at least, of the box 95 is painted black as well as the outward facing surface of the front panel 97. The windows 99 should be translucid dark acryllic panes such that the images 17 are practically invisible when the lamps 18 are unlit but convey maximum vision when the lamps 18 are on. These features lead to two more advantages. The train driver is not distracted by the pictures since no reflector tape is attached to the front driver part of the train 19. The second is that the pupil of the eye adjusts to a low level of illumination and therefore maximum contrast is achieved the moment the lamps 18 flash.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or step to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A system for conveying a moving image viewable to passengers on a moving vehicle, the system comprising:
a reel of sequential still image frames mounted along a reel distance, wherein the images which form the sequence of still images are taken from a film of sequential images and wherein distances between centres of adjacent frames in the sequence of still images are substantially constant along the reel distance;
trip means associated with each image for sensing the passage of the vehicle individually before each frame and outputting a trip signal;
lighting means associated with each image to individually illuminate the still-image frames in response to said trip signal and
means associated with each image for extending the duration of the lighting of each means so as to optimize reduction flickering, phantom images and shadow defects in the conveyed images.

2. The system of claim 1 wherein said lighting means illuminate each still-image frame for a predetermined time interval about 1 millisecond.

3. The system of claim 2 wherein said predetermined time interval is set between 0.5 and 1.5 milliseconds.

4. The system of claim 1 further comprising controller means for monitoring the time interval each image is lit and providing a predetermined dark interval before the same image is relit by inhibitting said lighting means from responding to said trip signal for a predetermined time interval.

5. The system of claim 4 wherein each frame is illuminated for a limited lighting period by at least one lamp which is illuminated in response to said trip signal.

6. The system of claim 5 wherein the lighting period is approximately equal to the time it takes the moving vehicle to pass one frame.

7. The system of claim 1 wherein each frame is illuminated for about 1 millisecond and then turned off.

8. The system of claim 4 wherein said predetermined dark interval before is substantially equal to 2 milliseconds or more.

9. The system of claim 5 wherein a dark translucent pane is mounted between each image and its corresponding lamp.

10. The system of claim 5 wherein said lighting means includes a lighting circuit board and a plurality of lamps evenly distributed around the edges of said board and said board is mounted behind said image.

11. The system of claim 10 wherein said plurality of lamps comprises four lamps centred behind each quadrant of said image.

12. The system of claim 5 wherein said lighting means includes laser lamps.

13. The system of claim 5 wherein said lighting means includes capacitor means for storing electrical charge prior to lighting each image, said lamps being lit by unloading the charge of said capacitor means onto said lamps.

14. The system of claim 13 wherein said capacitor means includes at least one LC circuit cell for sustaining higher initial current intensity during said capacitor charge unloading.

15. The system of claim 13 wherein said capacitor means are fully recharged prior to each lighting of said lamps by constant current intensity means.

16. The system of claim 13 wherein said lighting means includes thyristor means for gating said capacitor charge to said lamps under control of said controller means in response to said trip signal.

17. The system of claim 13 wherein said trip signal causes said capacitor means to recharge for a predetermined time interval before said controller means causes said lamp to be lit.

18. The system of claim 1 wherein said trip means includes an optical relay and reflector surfaces on at least some of said vehicles at a predetermined level.

19. The system of claim 19 wherein said optical relay includes an infrared light emitter and an infrared light detector and said trip means includes timer means for detecting a predetermined minimum continuous reflection time interval before generating said trip signal.

20. The system of claim 18 wherein said vehicle is an underground train and said refelector surface comprises tape extending along most of the length of said train, except for a train conductor portion at the front end of the train, at a predetermined height level with said optical array.

21. The system of claim 1 including box-shaped framework means mounted to wall surfaces of an underground train tunnel parallel to a pair of railway tracks, wherein said box-shaped framework means houses said means extending the lighting duration and said lighting means.

22. The system of claim 21, wherein said box-shaped framework means includes upper and lower guide means for sliding said reel in.

23. The system of claim 21, wherein said box-shaped framework means includes connector means for coupling electric power from one panel to adjacent panel, whereby a panel may be disconnected for maintenance or repai service by disconnecting said connector means at either side.

24. The system of claim 21, wherein said box-shaped framework means includes adjustable bracket means mounting it to the tunnel wall whereby all frames to be adjusted to the same height along the length of the tunnel.

25. The system of claim 21, wherein said box-shaped framework means is separated from the tunnel wall surface to let moisture or water run down in between.

26. The system of claim 1, wherein said reel comprises a plurality of reel segments, each reel segment comprising a predetermined number of said image frames.

27. The system of claim 26, wherein said reel segments comprise five image frames each.
